(19) United States
(12) Patent Application Publication
(10) Pub. No.: US 2011/0241308 A1
(43) Pub. Date: Oct. 6, 2011

(54) CHILDREN'S VEHICLE

(75) Inventor: Xue Sen Liao, Hsin Chu Hsien (TW)

(73) Assignee: HSIN LUNG ACCESSORIES CO., LTD., Hsin Chu Hsien (TW)

(21) Appl. No.: 12/771,170

(22) Filed: Apr. 30, 2010

(30) Foreign Application Priority Data
Apr. 1, 2010 (TW) 099205721

(51) Int. Cl. B62K 5/02

(52) U.S. Cl. 280/274

(57) ABSTRACT

A children's vehicle includes a frame and a head tube swingingly and pivotally coupled with each other, a position restoring element installed between the frame and the head tube, a front fork pivotally installed at a lower end of the head tube, a control rod installed at an upper end of the head tube and coupled to the front fork, at least one unidirectional rotating front wheel installed at the front fork, a carrier mounted onto the frame, and a freely rotating rear wheel installed separately on both sides of a rear end of the frame. After a child sits on the carrier, the child can turn the handle of the control rod by both hands, such that the frame can be swayed to drive the front wheel to move forward or backward according to the turning direction, so as to provide a sport game with fun and recreation.

### BACKGROUND OF THE INVENTION

1. Field of the Invention

The present invention generally relates to children's vehicles, and more particularly to a children's vehicle that features a simple installation, an easy and convenient operation, and a unique operating and riding mode, and achieves the purpose of a sport game with fun and recreation.

2. Description of the Related Art

With reference to FIG. 1 for a conventional children's vehicle, the children's vehicle comprises: a frame 10; a head tube 101 fixed to a front end of the frame 10; a front fork 20 pivotally installed to the head tube 101 by a pivot bolt 102; a front wheel 30 installed at a lower end of the front fork 20 through a pivot 201, wherein the pivot 201 and the front wheel 30 are integrated as a whole; a pedal 21 installed separately at both ends and with 180 degrees opposite to each other; a rear wheel 40 installed separately on both sides of a rear end of the frame 10, wherein the rear wheels 40 together with the front wheel 30 are provided for supporting the frame 10; and a carrier 50 installed at the top of the frame 10. After a child sits on the carrier 50, the child can step on the pedal 21 by both legs alternately and control a handlebar 22 installed at the top of the front fork 20 by both hands to achieve the purpose of riding the vehicle. Since the front wheel 30 and the pivot 201 are integrated as a whole, therefore the children's vehicle can be driven to move forward or backward by pedaling the pedals 21 by both legs, a smooth ride of such vehicle is easy for older or physically active children, but it may be difficult for a younger child who cannot step on the pedals 21 by both legs, and the younger child usually has to kick the legs against the ground to drive the vehicle, and the movement is unsmooth, non-adaptive and uncomfortable to the child.

### SUMMARY OF THE INVENTION

It is a primary objective of the present invention to overcome the shortcomings of the prior art by providing a children's vehicle that features a simple installation, an easy and convenient operation, and a unique operating and riding mode and achieves the purpose of a sport game with fun and recreation.

To achieve the foregoing objective, the present invention adopts the following technical measures. In the children's vehicle of the invention, a frame and a head tube are swingingly and pivotally coupled with each other, and a position restoring element is installed between the frame and the head tube, and a front fork is pivotally installed at a lower end of the head tube, and a control rod is installed at an upper end of the head tube and coupled to the front fork, and at least one unidirectional rotating front wheel installed at the front fork, and a carrier is mounted onto the frame, and a freely rotating rear wheel is installed separately on both sides of a rear end of the frame. After a child sits on the carrier, the child can turn the handles of the control rod by both hands, such that the frame can be swayed to drive the unidirectional rotating front wheel to move forward or backward according to the turning direction, and the child sitting on the carrier can be swayed accordingly to achieve the purpose of a sport game with fun and recreation.

To make it easier for our examiner to understand the objects, effects and advantages of the present invention, we use preferred embodiments with related drawings for the detailed description of the present invention as follows.

### BRIEF DESCRIPTION OF THE DRAWINGS

FIG. 1 is a perspective view of the conventional children's vehicle;

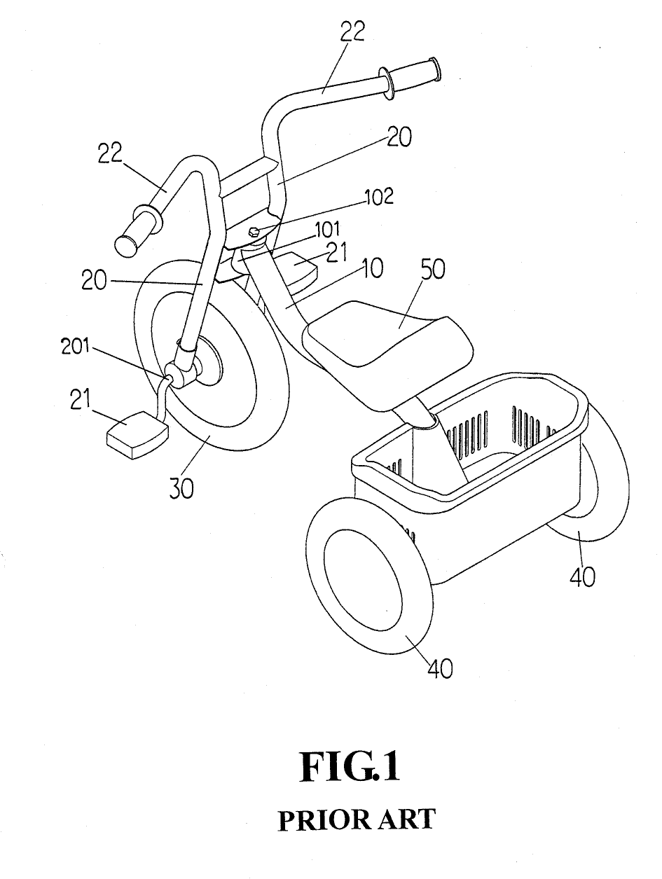

FIG. 2 is a perspective view of a preferred embodiment of the present invention;

FIG. 3 is a front view of FIG. 2;

FIG. 4 is a schematic view of a pivot portion of a frame and a head tube in accordance with the present invention;

FIG. 5 is a first schematic view of a forward movement in accordance with a preferred embodiment of the present invention;

FIG. 6 is a second schematic view of a forward movement in accordance with a preferred embodiment of the present invention;

FIG. 7 is a first schematic view of a backward movement in accordance with a preferred embodiment of the present invention;

FIG. 8 is a second schematic view of a backward movement in accordance with a preferred embodiment of the present invention; and

FIG. 9 is a perspective view of another preferred embodiment of the present invention.

### DETAILED DESCRIPTION OF THE PREFERRED EMBODIMENTS

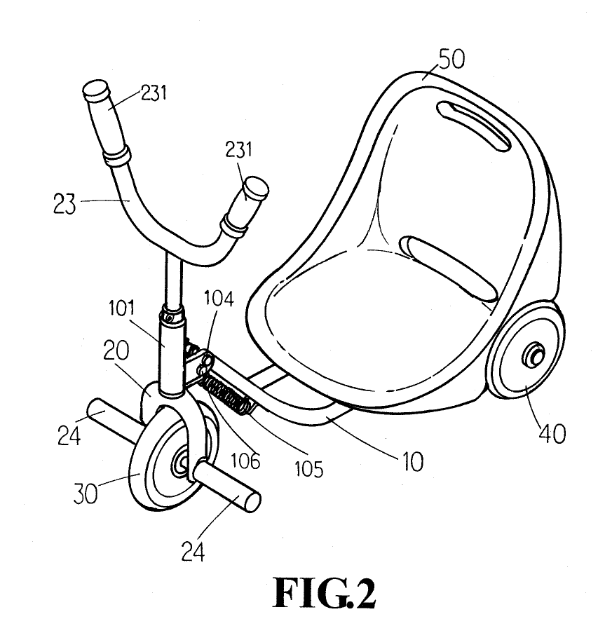

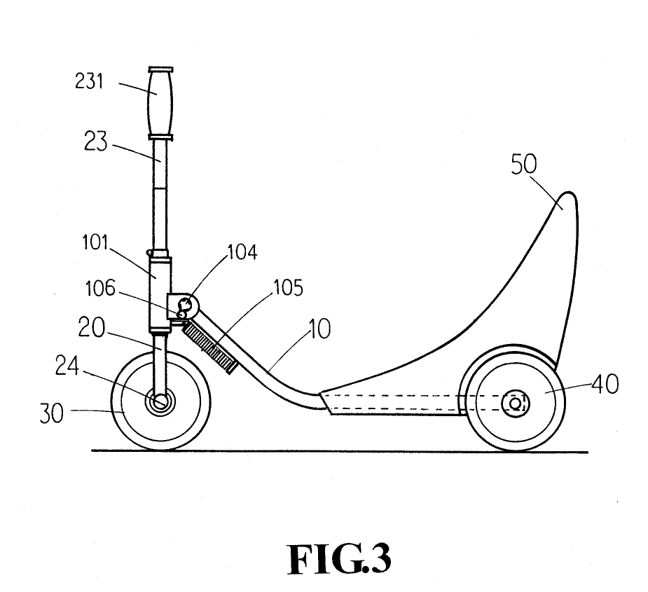

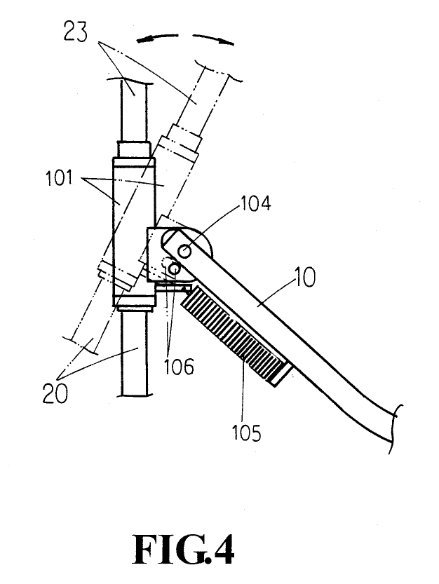

With reference to FIGS. 2 and 3 for a children's vehicle of the present invention, the children's vehicle comprises: a frame 10, a carrier 50 mounted onto the frame 10; a freely rotating rear wheel 40 installed separately on both sides of a rear end of the vehicle; a head tube 101 pivotally coupled to a front end of the vehicle; a front fork 20 pivotally installed at a lower end of the head tube 101 and having at least one front wheel 30 installed onto the front fork and a control rod 23 coupled to an upper end of the head tube 101, such that the front wheel 30 can be controlled and turned. The children's vehicle of the present invention is characterized in that the front wheel 30 is rotated unidirectionally, and the frame 10 and the head tube 101 are swingingly and pivotally coupled with each other by a pivot 104, and a position restoring element 105 is installed between the frame 10 and the head tube 101, such that the front wheel 30 installed at the front fork 20 maintains an elastic backward swaying action all the time, and a stop member 106 is installed between the head tube 101 and the frame 10 (as shown in FIG. 4). When the head tube 101 together with the front fork 20 and the front wheel 30 are swayed backward to a predetermined angle, the stop member 106 can stop the head tube 101 at the frame 10, such that the front and rear wheels 30, 40 can jointly support the frame 10 in a stable manner.

The control rod 23 includes a handle 231 installed thereon, and the control rod 23 can be turned to control the driving direction of the front wheel 30.

A footrest rod 24 is installed separately on both sides of the front fork 20 and provided for a child to rest the legs thereon.

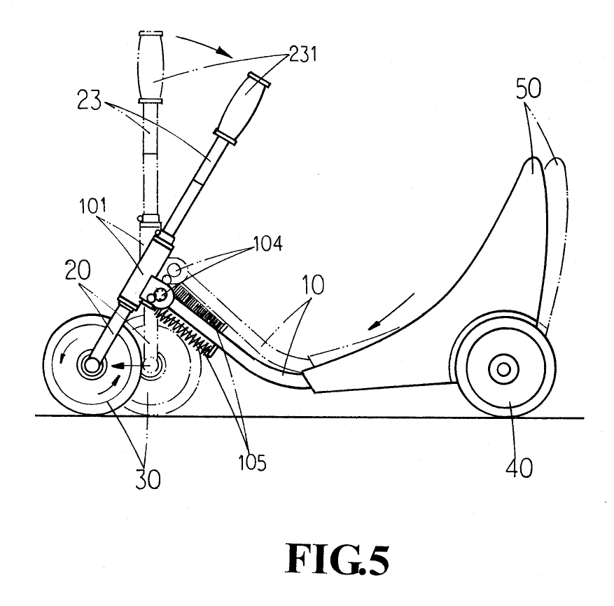

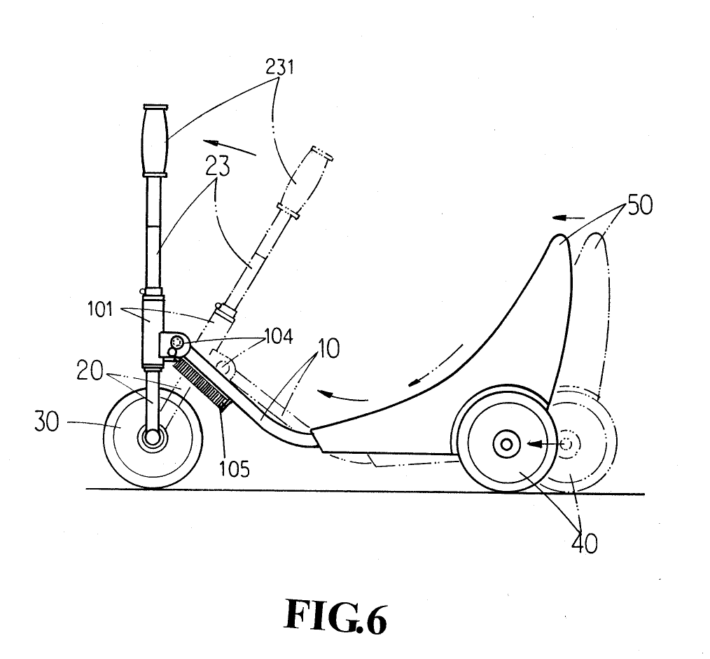

With reference to FIGS. 5 and 6 for the present invention, the head tube 101 and the frame 10 are swingingly and pivotally coupled with each other by the pivot 104, and a position restoring element 105 is installed between the head tube 101 and the frame 10, such that the front fork 20 and the front wheel 30 maintain the backward swaying action all the time. After a child sits on the carrier 50 of the frame 10, the child can hold the handles 231 of the control rod 23 by both hands to make a turn (as shown in FIG. 5). Since the front wheel 30 is rotated unidirectionally, the front wheel 30 can be rotated along a ground and moved forward according to the turning direction when the control rod 23 is turned backward by using the pivot 104 as a turning point. If the child no longer applies a force to sway the control rod 23 backward or push the control rod 23 to move forward (as shown in FIG. 6), the unidirectional rotating and forward moving front wheel 30 will remain stationary and will not be rotated in an opposite direction, so that the frame 10 can be pulled forward by the position restoring element 105 by using the front wheel 30 as a fixed point, and the control rod 23 can be swayed forward to return to its original position. With the freely rotating rear wheel 40, the child sitting on the carrier 50 can operate and drive the vehicle smoothly.

Since the frame 10 and the head tube 101 are swingingly and pivotally coupled to each other, therefore the front end of the frame 10 and the carrier 50 will be swayed downward automatically (as shown in FIG. 5) if the control rod 23 is swayed backward to drive the front wheel 30 to move forward. If the control rod 23 is swayed forward to restore its original position and drive the rear wheel 40 to move forward, the front end of the frame 10 and the carrier 50 will be swayed upward automatically again (as shown in FIG. 6). As the vehicle is driven to move forward, the carrier 50 will be moved and swayed curvedly upward and downward automatically, and the child sitting on the carrier 50 can be displaced accordingly to achieve the effect of a sport game with fun and recreation.

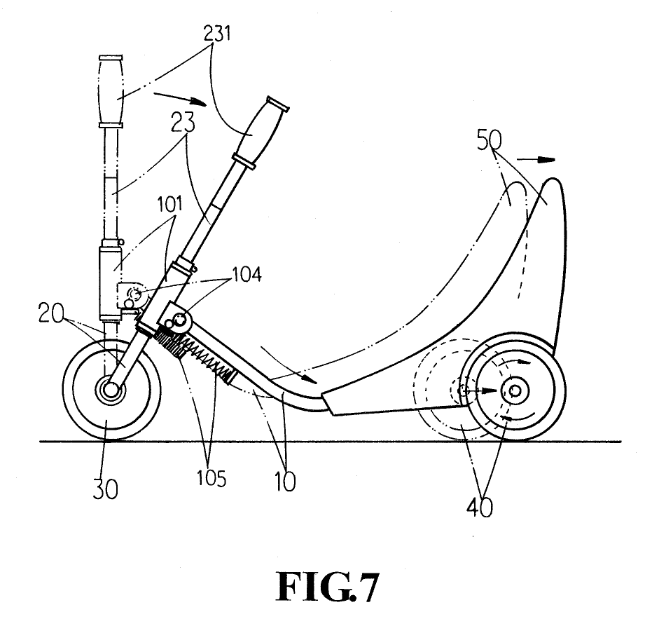

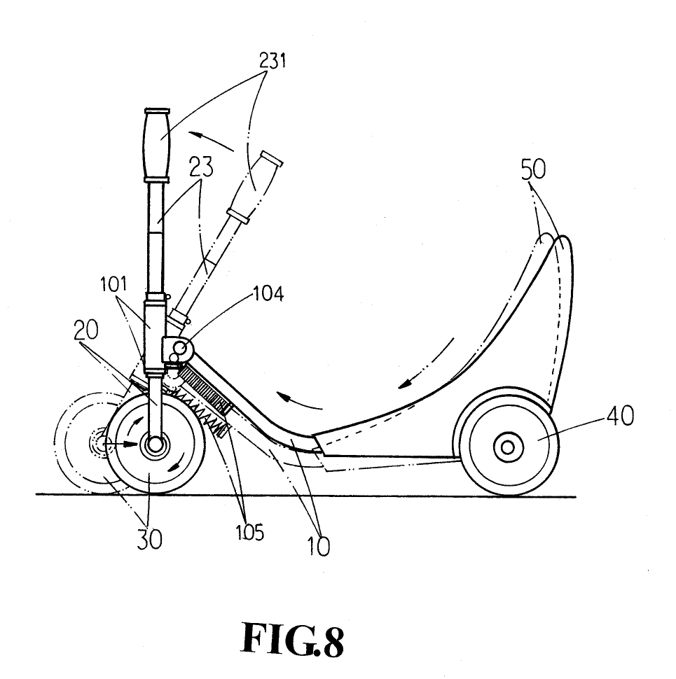

Since the control rod 23 together with the front fork 20 can be rotated freely at the head tube 101, therefore children can make a turn of 180 degrees of the control rod 23, such that the front fork 20 and the front wheel 30 can be turned together. In FIGS. 7 and 8, the front wheel 30 is rotated unidirectionally, such that if the control rod 23 is turned backward, the front wheel 30 will remain stationary, and the frame 10 and the carrier 50 will be pushed backward by using the front wheel 30 as a fixed point. With the assistance of the rear wheel 40, downward and backward curved swaying movements can be achieved (as shown in FIG. 7). If the child no longer applies a force to turn the control rod 23 backward or push the control rod 23 forward, the position restoring element 105 will provide a position restoring force to the control rod 23 originally swayed backward, and the unidirectional rotating front wheel 30 will be rotated automatically, and the control rod 23 will be swayed forward to return to its original position, and the front wheel 30 will be rotated and moved backward (as shown in FIG. 8), so that the originally downwardly swayed frame 10 and carrier 50 will be swayed curvedly upward to restore its original position. By the reciprocal operation of the control rod 23, the vehicle can be moved curvedly backward by means of the front and rear wheels 30, 40, so that the child sitting on the carrier 50 can have much fun, and the effect of a sport game with fun and recreation can be achieved.

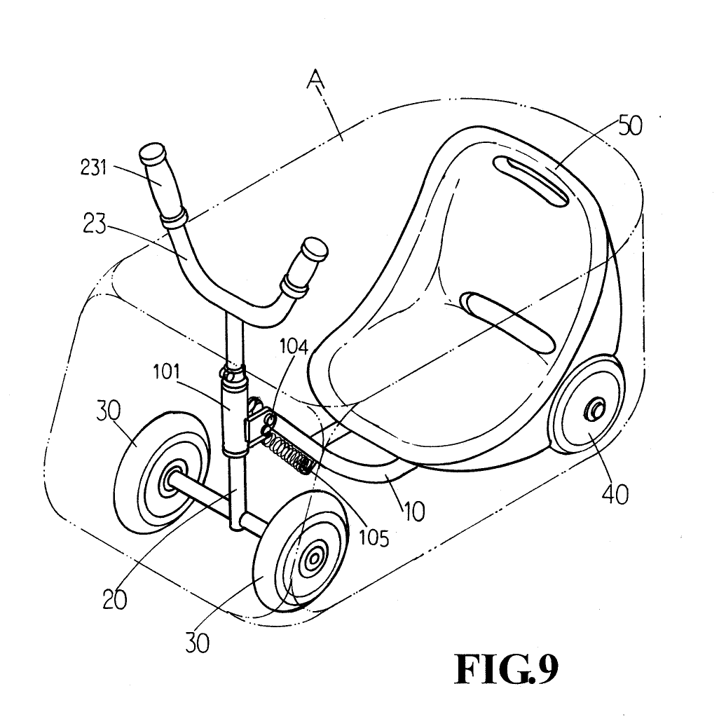

In FIG. 9, the unidirectionally rotating front wheel 30 can be installed directly and separately on both sides of the vehicle after the front fork 20 and the control rod 23 are coupled, such that the front wheel 30 corresponds to the rear wheel 40, or a casing A with different patterns (such as patterns of animals, dolls or cars) can be covered onto the exterior of the vehicle to extend the scope of the application and give more fun to the application.

In other words, the present invention at least has the following advantages:
1. The children's vehicle of the invention has the features of simple and easy installation and operation, and provides a convenient use.
2. The children's vehicle has a unique operating mode with fun and recreation, and children can enjoy riding the vehicle, and the use of the vehicle can achieve the expected purpose of a sport game.

In summation of the above description, the present invention herein enhances the performance than the conventional structure and further complies with the patent application requirements and is duly filed for patent application.

While the invention has been described by means of specific embodiments, numerous modifications and variations could be made thereto by those skilled in the art without departing from the scope and spirit of the invention set forth in the claims.

What is claimed is:

1. A children's vehicle, comprising: a frame, a carrier mounted onto the frame, a freely rotating rear wheel installed separately on both sides of a rear end of the frame, a head tube pivotally coupled to a front end of the frame, a front fork pivotally installed at a lower end of the head tube, a front wheel installed onto the front fork, and a control rod coupled to an upper end of the front fork, characterized in that the front wheel is rotated unidirectionally, and the frame and the head tube are swingingly and pivotally coupled with each other by a pivot, and a position restoring element is installed between the frame and the head tube, such that if the control rod is swayed forward and backward, the front wheel will be rotated and displaced along a ground according to the turning direction, and with the rear wheel, the frame and the carrier can be swayed curvedly and moved together with the front wheel.

2. The children's vehicle of claim 1, further comprising a stop member installed between the frame and the head tube for restricting an angle of swaying the front wheel backward.

3. The children's vehicle of claim 1, wherein the control rod includes a handle installed thereon.

4. The children's vehicle of claim 1, wherein the front fork includes a footrest rod installed separately on both sides of the front fork.

5. The children's vehicle of claim 1, wherein the unidirectional rotating front wheel comes with a quantity of one or more.
